(19) United States
(12) Patent Application Publication
(10) Pub. No.: US 2010/0263109 A1
(43) Pub. Date: Oct. 21, 2010

(54) MULTILAYER MATERIAL, COMPRISING AT LEAST TWO METALIZED LAYERS ON AT LEAST ONE TEXTILE, AND METHOD FOR THE PRODUCTION THEREOF

(75) Inventors: Ralf Noerenberg, Ludwigshafen (DE); Christian Steinig-Nowakowski, Deidesheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/744,004

(22) PCT Filed: Dec. 2, 2008
(86) PCT No.: PCT/EP08/66639

§ 371 Date: May 20, 2010

(30) Foreign Application Priority Data
Dec. 6, 2007 (DE) 102007055725.8

(51) Int. Cl. D06M 11/83; B32B 15/04; B32B 37/02; B29C 65/62; B32B 38/00; A41D 13/015

(52) U.S. Cl. 2/456; 428/551; 156/60; 156/93; 29/428

(57) ABSTRACT

Multi-ply materials comprise at least two metalized layers on at least one textile, produced by
(A) applying onto at least two textile surfaces, in the form of a pattern or uniformly, a formulation comprising at least one metal powder (a) as a component,
(B) depositing a further metal on the textile surfaces,
(C) combining with one or more plies of textile which may likewise each be metalized.

The present invention relates to multi-ply materials comprising at least two metalized layers on at least one textile, produced by
(A) applying onto at least two textile surfaces, in the form of a pattern or uniformly, a formulation comprising at least one metal powder (a) as a component,
(B) depositing a further metal on the textile surfaces,
(C) combining with one or more plies of textile which may likewise each be metalized.

The present invention further provides a process for producing multi-ply materials which are in accordance with the present invention and their use, for example for protective apparel and for mechanically stressed articles.

Protective apparel, for example sportswear for fencing, and textiles for mechanically severely stressed systems, for example car seats, have to protect against various mechanical threats. Examples are blunt blows, stabs and cuts and also thrown objects.

Various methods are proposed to achieve a better protective performance. For instance, various textile materials may be combined with each other to exploit the advantages of the various materials. The disadvantage is that such systems are very thick in many cases, which is often undesirable because of the pronounced warming effect in the case of sportswear.

Another method is to incorporate metal foils into textile composites. The disadvantage with this method is, however, that a metal foil with a crack or a point-shaped site of damage generally undergoes a severe loss of mechanical stability.

It is an object of the present invention to provide materials which have substantial mechanical stability and which avoid the aforementioned disadvantages.

We have found that this object is achieved by the multi-ply materials defined at the beginning.

The multi-ply materials of the present invention, hereinafter also referred to as inventive systems, comprise at least two metalized layers on at least one layer of textile, for example two textiles each metalized on one side or a both-sidedly metalized textile. In another embodiment, multi-ply materials in accordance with the present invention may comprise three, four or five textiles each metalized on one side. In another embodiment, multi-ply materials in accordance with the present invention may comprise three, four or five textiles each both-sidedly metalized. In another embodiment of the present invention, multi-ply materials in accordance with the present invention may comprise at least one one-sidedly metalized textile and at least one both-sidedly metalized textile.

In one embodiment of the present invention, multi-ply material in accordance with the present invention is characterized in that its outside layers (outer plies) each comprise a ply of textile not treated according to steps (A) and (B) or each treated on the inside surface according to steps (A) and (B), but not on the outside surface.

The process defined at the beginning proceeds from textile, in particular sheetlike textile or three-dimensionally elaborated textile material, for example a knit or preferably a woven fabric or a fibrous web nonwoven fabric. Textile for the purposes of the present invention can be stiff or preferably flexible. Preferably, textile comprises textiles which can be bent one or more times by hand for example without it being possible to detect a visual difference between before the bending and after the return from the bent state.

In one embodiment of the present invention, textile comprises a combination of various textiles which can be composited together. Combinations of wovens and knits may be mentioned by way of example.

Textile for the purposes of the present invention can be of natural fibers or synthetic fibers or mixtures of natural fibers and synthetic fibers. Useful natural fibers include for example, cotton, wool or flax. Useful synthetic fibers include for example polyamide, polyester, modified polyester, polyester blend fabric, polyamide blend fabric, polyacrylonitrile, triacetate, acetate, polycarbonate, polypropylene, polyvinyl chloride and polyester microfibers, preference being given to polyester and blends of cotton with synthetic fibers, in particular blends of cotton and polyester. Sheetlike textiles composed of carbon fibers, glass fibers or aramid fibers are also preferred.

In one embodiment of the present invention textile comprises parts of a composite. For instance, a ply of textile can be composited with another ply of textile, for example by adhering, quilting, laminating, stitching or needling, in each case uniformly, partly or else point-shapedly. More preferably, one ply of textile may be uniformly laminated, point-shapedly adhered, partly stitched or quilted with or to another ply of textile.

It is also possible for a textile material to be composited with another material in that the textile surface from which the process proceeds may be laminated onto a self-supporting film or sheet, for example a polyester self-supporting film or sheet, a polyolefin self-supporting film or sheet, in particular a polyethylene self-supporting film or sheet or a polypropylene self-supporting film or sheet, a polyamide self-supporting film or sheet or a polyurethane self-supporting film or sheet.

In one embodiment of the present invention, textile may comprise a coated textile surface, coated for example with binder such as polyurethane binder, polyacrylate binder or styrene-butadiene latex.

Especially when textile selected from wide-meshed knits and loose wovens is desired to be used as a constituent of a multi-ply material which is in accordance with the present invention, it may be advantageous for the wide-meshed knit in question or the wide-meshed woven in question to be used in coated form or to be laminated onto a self-supporting film or sheet.

Multi-ply materials according to the present invention are produced by applying in step (A) a formulation comprising at least one metal powder (a) onto at least two textile surfaces in the form of a pattern or uniformly. The applying can be effected for example by blade coating, spraying, roll coating, dipping and especially by printing.

The applying onto at least two textile surfaces can be accomplished for example by applying formulation (A) to the front and back of the same textile, or by applying formulation (A) to one or both of the sides of each of two or more textiles. It is preferred to apply formulation (A) to one side of each of at least two textiles.

The formulation comprising at least one metal powder (a) may comprise preferably aqueous formulations, in particular aqueous liquors or more preferably a printing formulation.

In one preferred embodiment of the present invention, at least two textile surfaces are printed in step (A) with a respective printing formulation, which may be different or preferably the same, preferably with an aqueous printing formulation comprising at least one metal powder (a).

Examples of aqueous printing formulations are printing inks, for example gravure printing inks, offset printing inks, flexographic printing inks, screenprinting inks, liquid inks such as for example inks for the Valvoline process (valve jet process) and preferably printing pastes, more preferably aqueous printing pastes.

Metal powder (a) comprises pulverulent metal, pure or as a mixture or alloy, although the alkali metals and the alkaline earth metals Be, Ca, Sr and Ba shall be excluded. Similarly, of course, the radioactive metals shall be excluded.

Metal powder (a) can be selected for example from pulverulent Al, Zn, Ni, Cu, Ag, Sn, Co, Mn, Fe, Mg, Pb, Cr and Bi, for example pure or as mixtures or in the form of pulverulent alloys of the specified metals with each other or with other metals. Examples of useful alloys are CuZn, CuSn, CuNi, SnPb, SnBi, SnCu, NiP, ZnFe, ZnNi, ZnCo and ZnMn. Preferred metal powders (a) which can be used are iron powder and/or copper powder, and very particular preference is given to iron powder.

In one specific variant, carbon is selected for use as metal powder (a), as graphite in particulate form, carbon black, soot or carbon nanotubes. This variant is particularly preferred when hereinbelow described step (B) utilizes an external source of voltage. Carbon as graphite in particulate form, carbon black, soot or carbon nanotubes is cocomprehended under the term metal powder (a) in the realm of the present invention.

One specific variant utilizes as metal powder (a) a mixture of pulverulent Al, Zn, Ni, Cu, Ag, Sn, Co, Mn, Fe, Mg, Pb, Cr and Bi, especially iron powder on the one hand and, on the other, carbon as graphite in particulate form, carbon black, soot or carbon nanotubes.

In one embodiment of the present invention, metal powder (a) has an average particle diameter in the range from 0.01 to 100 μm, preferably in the range from 0.1 to 50 μm and more preferably in the range from 1 to 10 μm (determined by laser diffraction measurement, for example using a Microtrac X100).

In one embodiment, metal powder (a) is characterized by its particle diameter distribution. For example, the d₁₀ value can be in the range from 0.01 to 5 μm, the d₅₀ value in the range from 1 to 10 μm and the d₉₀ value in the range from 3 to 100 μm, subject to the condition: d₁₀<d₅₀<d₉₀. Preferably, no particle has a diameter greater than 100 μm.

Metal powder (a) can be used in passivated form, for example in an at least partially/partly coated form. Examples of useful coatings include inorganic layers such as oxide of the metal in question, SiO₂ or SiO₂.aq or phosphates for example of the metal in question.

The particles of metal powder (a) can in principle have any desired shape in that for example acicular, cylindrical, lamellar or spherical particles can be used, preference being given to spherical and lamellar particles. The expressions acicular, cylindrical, lamellar and spherical can each relate to idealized forms.

It is particularly preferable to use metal powders (a) having spherical particles, preferably predominantly having spherical particles, most preferably so-called carbonyl iron powders having spherical particles.

Another particularly preferred embodiment utilizes metal powders (a) that are a mixture of spherical particles, most preferably so-called carbonyl iron powders having spherical particles, and lamellar particles, in particular lamellar particles of copper.

Metal powder (a) can in one embodiment of step (A) be applied, preferably printed, such that the particles of metal powder come to lie so close together that they are already capable of conducting electric current. In another embodiment of step (A), metal powder (a) can be applied, preferably printed, such that the particles of metal powder (a) are so far apart from each other that they are not capable of conducting electric current.

The production of metal powders (a) is known per se. For example, common commercial goods can be used or metal powders (a) produced by processes known per se, for example by electrolytic deposition or chemical reduction from solutions of salts of the metals in question or by reduction of an oxidic powder for example by means of hydrogen, by spraying or jetting a molten metal, in particular into cooling media, for example gases or water.

Particular preference is given to using such metal powder (a) as was produced by thermal decomposition of iron pentacarbonyl, herein also referred to as carbonyl iron powder.

The production of carbonyl iron powder by thermal decomposition of, in particular, iron pentacarbonyl Fe(CO)₅ is described for example in Ullmann's Encyclopedia of Industrial Chemistry, 5^{th} Edition, Volume A14, page 599. The decomposition of iron pentacarbonyl can be effected for example at atmospheric pressure and for example at elevated temperatures, for example in the range from 200 to 300° C., for example in a heatable decomposer comprising a tube of heat-resistant material such as quartz glass or V2A steel in a preferably vertical position, the tube being surrounded by heating means, for example consisting of heating tapes, heating wires or a heating mantle through which a heating medium flows.

The average particle diameter of carbonyl iron powder can be controlled within wide limits via the process parameters and reaction management in relation to the decomposition stage, and is in terms of the number average in general in the range from 0.01 to 100 μm, preferably in the range from 0.1 to 50 μm and more preferably in the range from 1 to 8 μm.

In one embodiment of the present invention, step (A) utilizes a formulation, preferably a printing formulation, comprising:
(a) at least one metal powder, preference being given to carbonyl iron powder,
(b) at least one binder,
(c) at least one emulsifier, which may be anionic, cationic or preferably nonionic,
(d) if appropriate at least one rheology modifier.

Formulations, especially printing formulations, used according to the present invention may comprise at least one binder (b), preferably at least one aqueous dispersion of at least one film-forming polymer, for example polyacrylate, polybutadiene, copolymers of at least one vinylaromatic with at least one conjugated diene and if appropriate further comonomers, for example styrene-butadiene binders. Further suitable binders (b) are selected from polyurethane, preferably anionic polyurethane, or ethylene-(meth)acrylic acid copolymer.

Useful binder (b) polyacrylates for the purposes of the present invention are obtainable for example by copolymerization of at least one C₁-C₁₀-alkyl(meth)acrylate, for example methyl acrylate, ethyl acrylate, n-butyl acrylate, n-butyl methacrylate, 2-ethylhexyl acrylate, with at least one further comonomer, for example with a further C₁-C₁₀-alkyl(meth)acrylate, (meth)acrylic acid, (meth)acrylamide, N-methylol(meth)acrylamide, glycidyl(meth)acrylate or a vinylaromatic compound such as styrene for example.

Useful binder (b) polyurethanes for the purposes of the present invention, which are preferably anionic, are obtainable for example by reaction of one or more aromatic or preferably aliphatic or cycloaliphatic diisocyanates with one or more polyesterdiols and preferably one or more hydroxy carboxylic acids, for example hydroxyacetic acid, or preferably dihydroxy carboxylic acids, for example 1,1-dimethylolpropionic acid, 1,1-dimethylolbutyric acid or 1,1-dimethylolethanoic acid.

Particularly useful binder (b) ethylene-(meth)acrylic acid copolymers are obtainable for example by copolymerization of ethylene, (meth)acrylic acid and if appropriate at least one further comonomer such as for example C₁-C₁₀-alkyl(meth)acrylate, maleic anhydride, isobutene or vinyl acetate, preferably by copolymerization at temperatures in the range from 190 to 350° C. and pressures in the range from 1500 to 3500 bar and preferably in the range from 2000 to 2500 bar.

Particularly useful binder (b) ethylene-(meth)acrylic acid copolymers may for example comprise up to 90% by weight of interpolymerized ethylene and have a kinematic melt viscosity in the range from 60 mm²/s to 10 000 mm²/s, preferably in the range from 100 mm²/s to 5000 mm²/s, measured at 120° C.

Particularly useful binder (b) ethylene-(meth)acrylic acid copolymers may for example comprise up to 90% by weight of interpolymerized ethylene and have a melt flow rate (MFR) in the range from 1 to 50 g/10 min, preferably in the range from 5 to 20 g/10 min and more preferably in the range from 7 to 15 g/10 min, measured at 160° C. under a load of 325 g in accordance with EN ISO 1133.

Particularly useful binder (b) copolymers of at least one vinylaromatic with at least one conjugated diene and if appropriate further comonomers, for example styrene-butadiene binders, comprise at least one ethylenically unsaturated carboxylic acid or dicarboxylic acid or a suitable derivative, for example the corresponding anhydride, in interpolymerized form. Particularly suitable vinylaromatics are para-methylstyrene, α-methylstyrene and especially styrene. Particularly suitable conjugated dienes are isoprene, chloroprene and in particular 1,3-butadiene. Particularly suitable ethylenically unsaturated carboxylic acids or dicarboxylic acids or suitable derivatives thereof are (meth)acrylic acid, maleic acid, itaconic acid, maleic anhydride or itaconic anhydride, to name just some examples.

In one embodiment of the present invention, particularly suitable binder (b) copolymers of at least one vinylaromatic with at least one conjugated diene and if appropriate further comonomers comprise in interpolymerized form:

19.9% to 80% by weight of vinylaromatic,
19.9% to 80% by weight of conjugated diene,
0.1% to 10% by weight of ethylenically unsaturated carboxylic acid or dicarboxylic acid
or a suitable derivative, for example the corresponding anhydride.

In one embodiment of the present invention, binder (b) has a dynamic viscosity at 23° C. in the range from 10 to 100 dPa·s and preferably in the range from 20 to 30 dPa·s, determined for example by rotary viscometry, for example using a Haake viscometer.

Emulsifier (c) may be an anionic, cationic or preferably nonionic surface-active substance.

Examples of suitable cationic emulsifiers (c) are for example C₆-C₁₈-alkyl-, -aralkyl- or heterocyclyl-containing primary, secondary, tertiary or quaternary ammonium salts, alkanolammonium salts, pyridinium salts, imidazolinium salts, oxazolinium salts, morpholinium salts, thiazolinium salts and also salts of amine oxides, quinolinium salts, isoquinolinium salts, tropylium salts, sulfonium salts and phosphonium salts. Examples which may be mentioned are dodecylammonium acetate or the corresponding hydrochloride, the chlorides or acetates of the various 2-(N,N,N-trimethylammonium)-ethylparaffinic esters, N-cetylpyridinium chloride, N-laurylpyridinium sulfate and also N-cetyl-N,N,N-trimethylammonium bromide, N-dodecyl-N,N,N-trimethylammonium bromide, N,N-distearyl-N,N-dimethylammonium chloride and also the gemini surfactant N,N′-(lauryldimethyl)ethylenediamine dibromide.

Examples of suitable anionic emulsifiers (c) are alkali metal and ammonium salts of alkyl sulfates (alkyl radical: C₈ to C₁₂), of sulfuric acid monoesters of ethoxylated alkanols (degree of ethoxylation: 4 to 30, alkyl radical: C₁₂-C₁₈) and of ethoxylated alkylphenols (degree of ethoxylation: 3 to 50, alkyl radical: C₄-C₁₂), of alkylsulfonic acids (alkyl radical: C₁₂-C₁₈), of alkylarylsulfonic acids (alkyl radical: C₉-C₁₈) and of sulfosuccinates such as for example sulfosuccinic mono- or diesters. Preference is given to aryl- or alkyl-substituted polyglycol ethers and also to substances described in U.S. Pat. No. 4,218,218, and homologs with y (from the formulae of U.S. Pat. No. 4,218,218) in the range from 10 to 37.

Particular preference is given to nonionic emulsifiers (c) such as for example singly or preferably multiply alkoxylated C₁₀-C₃₀ alkanols, preferably with three to one hundred mol of C₂-C₄-alkylene oxide, in particular ethoxylated oxo process or fatty alcohols.

Examples of particularly suitable multiply alkoxylated fatty alcohols and oxo process alcohols are

n-C₁₈H₃₇O—(CH₂CH₂O)₈₀—H,
n-C₁₈H₃₇O—(CH₂CH₂O)₇₀—H,
n-C₁₈H₃₇O—(CH₂CH₂O)₆₀—H,
n-C₁₈H₃₇O—(CH₂CH₂O)₅₀—H,
n-C₁₈H₃₇O—(CH₂CH₂O)₂₅—H,
n-C₁₈H₃₇O—(CH₂CH₂O)₁₂—H,
n-C₁₆H₃₃O—(CH₂CH₂O)₈₀—H,
n-C₁₆H₃₃O—(CH₂CH₂O)₇₀O—H,
n-C₁₆H₃₃O—(CH₂CH₂O)₆₀—H,
n-C₁₆H₃₃O—(CH₂CH₂O)₅₀—H,
n-C₁₆H₃₃O—(CH₂CH₂O)₂₅—H,
n-C₁₆H₃₃O—(CH₂CH₂O)₁₂—H,
n-C₁₂H₂₅O—(CH₂CH₂O)₁₁—H,
n-C₁₂H₂₅O—(CH₂CH₂O)₁₈—H,
n-C₁₂H₂₅O—(CH₂CH₂O)₂₅—H,
n-C₁₂H₂₅O—(CH₂CH₂O)₅₀—H,
n-C₁₂H₂₅O—(CH₂CH₂O)₈₀—H,
n-C₃₀H₆₁O—(CH₂CH₂O)₈—H,
n-C₁₀H₂₁O—(CH₂CH₂O)₉—H,
n-C₁₀H₂₁O—(CH₂CH₂O)₇—H,
n-C₁₀H₂₁O—(CH₂CH₂O)₅—H,
n-C₁₀H₂₁O—(CH₂CH₂O)₃—H,
and mixtures of the aforementioned emulsifiers, for example mixtures of n-C₁₈H₃₇O—(CH₂CH₂O)₅₀—H and n-C₁₆H₃₃O—(CH₂CH₂O)₅₀—H,
the indices each being number averages.

In one embodiment of the present invention, formulations, especially printing formulations, used in step (A) can comprise at least one rheology modifier (d) selected from thickeners (d1) and viscosity reducers (d2).

Suitable thickeners (d1) are for example natural thickeners or preferably synthetic thickeners. Natural thickeners are such thickeners as are natural products or are obtainable from natural products by processing such as purifying operations for example, in particular extraction. Examples of inorganic natural thickeners are sheet silicates such as bentonite for example. Examples of organic natural thickeners are preferably proteins such as for example casein or preferably polysaccharides. Particularly preferred natural thickeners are selected from agar agar, carrageenan, gum arabic, alginates such as for example sodium alginate, potassium alginate, ammonium alginate, calcium alginate and propylene glycol alginate, pectins, polyoses, carob bean flour (carubin) and dextrins.

Preference is given to using synthetic thickeners selected from generally liquid solutions of synthetic polymers, in particular acrylates, in for example white oil or as aqueous solutions, and from synthetic polymers in dried form, for example spray-dried powders. Synthetic polymers used as thickeners (d1) comprise acid groups, which are neutralized with ammonia completely or to a certain percentage. In the course of the fixing operation, ammonia is released, reducing the pH and starting the actual fixing process. The pH reduction necessary for fixing may alternatively be effected by adding nonvolatile acids such as for example citric acid, succinic acid, glutaric acid or malic acid.

Very particularly preferred synthetic thickeners are selected from copolymers of 85% to 95% by weight of acrylic acid, 4% to 14% by weight of acrylamide and 0.01 to not more than 1% by weight of the (meth)acrylamide derivative of the formula I

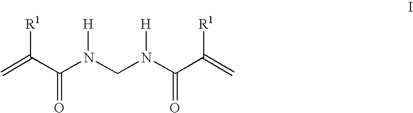

having molecular weights M_{w} in the range from 100 000 to 2 000 000 g/mol, in each of which the R¹ radicals may be the same or different and may represent methyl or hydrogen.

Further suitable thickeners (d1) are selected from reaction products of aliphatic diisocyanates such as for example trimethylene diisocyanate, tetramethylene diisocyanate, hexamethylene diisocyanate or 1,12-dodecane diisocyanate with preferably 2 equivalents of multiply alkoxylated fatty alcohol or oxo process alcohol, for example 10 to 150-tuply ethoxylated C₁₀-C₃₀ fatty alcohol or C₁₁-C₃₁ oxo process alcohol.

Suitable viscosity reducers (d2) are for example organic solvents such as dimethyl sulfoxide (DMSO), N-methylpyrrolidone (NMP), N-ethylpyrrolidone (NEP), ethylene glycol, diethylene glycol, butylglycol, dibutylglycol and for example alkoxylated n-C₄-C₈-alkanol free of residual alcohol, preferably singly to 10-tuply and more preferably 3- to 6-tuply ethoxylated n-C₄-C₈-alkanol free of residual alcohol. Residual alcohol refers to the respectively nonalkoxylated n-C₄-C₈-alkanol.

In one embodiment of the present invention, the formulation, especially printing formulation, used in step (A) comprises

from 10% to 90% by weight, preferably from 50% to 85% by weight and more preferably from 60% to 80% by weight of metal powder (a),
from 1% to 20% by weight and preferably from 2% to 15% by weight of binder (b),
from 0.1% to 4% by weight and preferably up to 2% by weight of emulsifier (c),
from 0% to 5% by weight and preferably from 0.2% to 1% by weight of rheology modifier (d),
weight % ages each being based on the entire formulation or to be more precise printing formulation used in step (A) and relating in the case of binder (b) to the solids content of the respective binder (b).

One embodiment of the present invention comprises printing in step (A) of the process of the present invention with a formulation, especially printing formulation, which, in addition to metal powder (a) and if appropriate binder (b), emulsifier (c) and if appropriate rheology modifier (d), comprises at least one auxiliary (e). Examples of suitable auxiliaries (e) are hand improvers, defoamers, wetting agents, leveling agents, urea, corrosion inhibitors, actives such as for example biocides or flame retardants and crosslinkers.

Suitable defoamers are for example siliconic defoamers such as for example those of the formula HO—(CH₂)₃—Si(CH₃)[OSi(CH₃)₃]₂ and HO—(CH₂)₃—Si(CH₃)[OSi(CH₃)₃][OSi(CH₃)₂OSi(CH₃)₃], nonalkoxylated or alkoxylated with up to 20 equivalents of alkylene oxide and especially ethylene oxide. Silicone-free defoamers are also suitable, examples being multiply alkoxylated alcohols, for example fatty alcohol alkoxylates, preferably 2 to 50-tuply ethoxylated preferably unbranched C₁₀-C₂₀ alkanols, unbranched C₁₀-C₂₀ alkanols and 2-ethylhexan-1-ol. Further suitable defoamers are fatty acid C₈-C₂₀-alkyl esters, preferably C₁₀-C₂₀-alkyl stearates, in each of which C₈-C₂₀-alkyl and preferably C₁₀-C₂₀-alkyl may be branched or unbranched.

Suitable wetting agents are for example nonionic, anionic or cationic surfactants, in particular ethoxylation and/or propoxylation products of fatty alcohols or propylene oxide-ethylene oxide block copolymers, ethoxylated or propoxylated fatty or oxo process alcohols, also ethoxylates of oleic acid or alkylphenols, alkylphenol ether sulfates, alkylpolyglycosides, alkyl phosphonates, alkylphenyl phosphonates, alkyl phosphates or alkylphenyl phosphates.

Suitable leveling agents are for example block copolymers of ethylene oxide and propylene oxide having molecular weights Mₙ in the range from 500 to 5000 g/mol and preferably in the range from 800 to 2000 g/mol. Very particular preference is given to block copolymers of propylene oxide-ethylene oxide for example of the formula EO₈PO₇EO₈, where EO represents ethylene oxide and PO represents propylene oxide.

Suitable biocides are for example commercially obtainable as Proxel brands. Examples which may be mentioned are: 1,2-benzisothiazolin-3-one (BIT) (commercially obtainable as Proxel® brands from Avecia Lim.) and its alkali metal salts; other suitable biocides are 2-methyl-2H-isothiazol-3-one (MIT) and 5-chloro-2-methyl-2H-isothiazol-3-one (CIT).

Suitable crosslinkers are for example condensation products of glyoxal, urea, formaldehyde and optionally one or more alcohols such as C₁-C₄-alkanols or ethylene glycol, in particular DMDHEU (N,N′-dihydroxymethylol-4,5-dihydroxymethyleneurea), melamin and condensation products of melamin with aldehydes, in particular formaldehyde, and optionally one or more alcohols such as C₁-C₄-alkanols or ethylene glycol, isocyanurates, in particular cyclic trimers of hexamethylene diisocyanate, and carbodiimides, in particular polymeric carbodiimides.

In one embodiment of the present invention, the formulation, especially printing formulation, used in step (A) comprises up to 30% by weight of auxiliary (e), based on the sum total of metal powder (a), binder (b), emulsifier (c) and if appropriate rheology modifier (d).

One embodiment of the present invention comprises applying in step (A) patterns, especially by printing, wherein metal powders (a) are arranged on textile in the form of straight or preferably bent stripy patterns or line patterns, wherein the lines mentioned may have for example a breadth and thickness each in the range from 0.1 μm to 5 mm and the stripes mentioned may have for example a breadth in the range from 5.1 mm to for example 10 cm or if appropriate more and a thickness in the range from 0.1 μm to 5 mm.

One specific embodiment of the present invention comprises applying in step (A) stripy patterns or line patterns of metal powder (a), especially by printing, wherein the stripes and lines, respectively, neither touch nor intersect.

In another embodiment of the present invention, a formulation is applied uniformly in step (A).

In one embodiment of the present invention, printing in step (A) is effected by various processes which are known per se. One embodiment of the present invention utilizes a stencil through which the formulation, especially printing formulation, comprising metal powder (a) is pressed using a squeegee. The process described above is a screen printing process. Useful printing processes further include gravure printing processes and flexographic printing processes. A further useful printing process is selected from valve-jet processes. Valve-jet processes utilize printing formulation comprising preferably no thickener (d1).

To produce multi-ply materials which are in accordance with the present invention, a further metal is deposited on the textile surface in step (B). One or more further metals may be deposited in step (B), but it is preferable to deposit just one further metal.

To produce multi-ply materials which are in accordance with the present invention, a further metal is deposited on the textile surface in step (B). “Textile surface” here refers to the textile surfaces previously processed according to steps (A) to (B) and if appropriate further steps such as (D) for example.

A plurality of further metals may be deposited in step (B), but it is preferable to deposit just one further metal.

One embodiment of the present invention utilizes carbonyl iron powder as metal powder (a) in step (A) and silver, gold or especially copper as further metal in step (C).

In one embodiment of the present invention, sufficient further metal is deposited to produce a layer thickness in the range from 100 nm to 500 μm, preferably in the range from 1 μm to 100 μm and more preferably in the range from 2 μm to 50 μm.

In the practice of step (B), metal powder (a) is in most cases partially or completely replaced by further metal and the morphology of further deposited metal need not be identical to the morphology of metal powder (a).

On completion of the deposition of further metal (B) metalized textile surfaces are obtained. Metalized textile surfaces may additionally be rinsed one or more times, for example with water.

In one embodiment of the present invention, metalized textiles printed with a line or stripe pattern have after step (B) a specific resistance of respectively in the range from 1 mΩg/cm² to 1 MΩ/cm² and in the range from 1 μΩ/cm to 1 MΩ/cm, measured at room temperature and along the stripes and lines in question.

Step (C) comprises combining at least one textile metalized as described above with one or more plies of textile which may likewise each be metalized. The combining may be accomplished for example by placing on top of each other, for example by laying on top of each other.

After the placing on top of each other, three or more plies of textile, metalized or non-metalized, may be composited with each other to produce a composite article. The compositing may be accomplished uniformly or partially, for example at points (point-shapedly) or in the form of seams.

The compositing can be accomplished for example by stitching, needling, adhering, quilting, laminating or welding, in each case uniformly, partly or else point-shapedly. More preferably, one ply of textile may be uniformly laminated, point-shapedly adhered, partly stitched or quilted with or to another ply of textile.

Multi-ply materials according to the present invention are useful as or in the manufacture of protective apparel, which likewise forms part of the subject matter of the present invention. The present invention further provides for the use of multi-ply materials which are in accordance with the present invention in the manufacture of protective apparel, and the present invention further provides a process for manufacturing protective apparel using multi-ply materials which are in accordance with the present invention. Manufacturing can take the form of making up.

Protective apparel is to be understood as meaning for example sportswear, for example vests or gloves for competitive fencers or garments for participants in paintball tournaments, also for film actors and stuntmen.

Protective apparel according to the present invention is very suitable for protecting against blunt blows, stabs and cuts and also thrown objects. Protective apparel according to the present invention is easy to manufacture and need not be thick, so that it even offers high wearing comfort at comparatively high temperatures.

Ballistic-resistant clothing is also conceivable, examples being so-called bulletproof vests.

Multi-ply materials according to the present invention are useful as or in the manufacture of mechanically stressed articles, which likewise forms part of the subject matter of the present invention. The present invention further provides for the use of multi-ply materials which are in accordance with the present invention in the manufacture of mechanically stressed articles, and the present invention further provides a process for manufacturing mechanically stressed articles using multi-ply materials which are in accordance with the present invention.

Mechanically stressed articles may be stressed for example through stabs, rubbing, cutting or pressure. Examples are the side portions of automotive seats, which are greatly stressed by people climbing in or out of the vehicle, also seats including the backrests in public means of transport, which can suffer a wide variety of forms of willful damage as well as suffering the effects of passengers getting on and off.

The present invention further provides a process for producing multi-ply materials which are in accordance with the present invention, hereinafter also referred to as inventive production process.

The inventive production process comprises
(A) applying onto at least two textile surfaces, in the form of a pattern or uniformly, a formulation comprising at least one metal powder (a) as a component,
(B) depositing a further metal on the textile surfaces,
(C) combining with one or more plies of textile which may likewise each be metalized.

In one embodiment of the present invention, at least one formulation in step (A) comprises an aqueous formulation.

Details concerning the formulations used in step (A) are described above.

A formulation comprising metal powder (a) may be applied in step (A) by spraying, blade coating or dipping for example. Preferably, the applying is embodied as printing.

One embodiment of the present invention comprises applying in step (A) patterns, especially by printing, wherein metal powders (a) are arranged on textile in the form of straight or preferably bent stripy patterns or line patterns, wherein the lines mentioned may have for example a breadth and thickness each in the range from 0.1 μm to 5 mm and the stripes mentioned may have for example a breadth in the range from 5.1 mm to for example 10 cm or if appropriate more and a thickness in the range from 0.1 μm to 5 mm.

One specific embodiment of the present invention comprises applying in step (A) stripy patterns or line patterns of metal powder (a), especially by printing, wherein the stripes and lines, respectively, neither touch nor intersect.

In another embodiment of the present invention, at least one formulation is applied uniformly in step (A), i.e., over the whole area.

In one embodiment of the present invention, printing in step (A) is effected by various processes which are known per se. One embodiment of the present invention utilizes a stencil through which the formulation, especially printing formulation, comprising metal powder (a) is pressed using a squeegee. The process described above is a screen printing process. Useful printing processes further include gravure printing processes and flexographic printing processes. A further useful printing process is selected from valve-jet processes. Valve-jet processes utilize printing formulation comprising preferably no thickener (d1).

In one embodiment of the present invention, the formulation, especially printing formulation, used in the process according to the present invention comprises up to 30% by weight of auxiliary (e), based on the sum total of metal powder (a), binder (b), emulsifier (c) and if appropriate rheology modifier (d).

Formulations, especially printing formulations, used in the process of the present invention may be produced by mixing
(a) at least one metal powder, particular preference being given to carbonyl iron powder,
(b) at least one binder,
(c) at least one emulsifier, and
(d) if appropriate at least one rheology modifier, and also if appropriate one or more auxiliaries (e) together in any order.

To produce formulation, especially printing formulation, used in the process of the present invention, one possible procedure is for example to stir together water and if appropriate one or more auxiliaries, for example a defoamer, for example a silicone-based defoamer. Thereafter, one or more emulsifiers can be added.

Next, one or more hand improvers can be added, for example one or more silicone emulsions.

Thereafter one or more emulsifiers (c) and the metal powder or powders (a) can be added.

Subsequently, one or more binders (b) and finally if appropriate one or more rheology modifiers (d) can be added and the mixture homogenized with continued mixing, for example by stirring. Sufficient stirring times are customarily comparatively short, for example in the range from 5 seconds to 5 minutes and preferably in the range from 20 seconds to 1 minute at stirrer speeds in the range from 1000 to 3000 rpm.

The final formulation, especially printing formulation, in accordance with the present invention may comprise 30% to 70% by weight of white oil when it is to be used as a printing paste. Aqueous synthetic thickeners (d1) preferably comprise up to 25% by weight of synthetic polymer useful as thickener (d1). To use aqueous formulations of thickener (d1), aqueous ammonia is generally added. Similarly, the use of granular, solid formulations of thickener (c) are usable in order that prints may be produced emissionlessly.

In one embodiment of the present invention, hereinafter also referred to as step (B1), no external source of voltage is used in step (B1) and the further metal in step (B1) has a more strongly positive standard potential in the electrochemical series of the elements, in alkaline or preferably in acidic solution, than the metal underlying metal powder (a) and than hydrogen.

One possible procedure is for textile surface printed in step (A) and thermally treated in step (B) to be treated with a basic, neutral or preferably acidic preferably aqueous solution of salt of further metal and if appropriate one or more reducing agents, for example by placing it into the solution in question.

One embodiment of the present invention comprises treating in step (B1) in the range from 0.5 minutes to 12 hours and preferably up to 30 minutes.

One embodiment of the present invention comprises treating in step (B1) with a basic, neutral or preferably acidic solution of salt of further metal, the solution having a temperature in the range from 0 to 100° C. and preferably in the range from 10 to 80° C.

One or more reducing agents may be additionally added in step (B1). When, for example, copper is chosen as further metal, possible reducing agents added include for example aldehydes, in particular reducing sugars or formaldehyde as reducing agent. When, for example, nickel is chosen as further metal, examples of reducing agents which can be added include alkali metal hypophosphite, in particular NaH₂PO₂.2H₂O, or boranates, in particular NaBH₄.

In another embodiment, hereinafter also referred to as step (B2), of the present invention, an external source of voltage is used in step (B2) and the further metal in step (B2) can have a more strongly or more weakly positive standard potential in the electrochemical series of the elements in acidic or alkaline solution than the metal underlying metal powder (a). Preferably, carbonyl iron powder may be chosen for this as metal powder (a) and nickel, zinc or in particular copper as further metal. In the event that the further metal in step (B2) has a more strongly positive standard potential in the electrochemical series of the elements than hydrogen and than the metal underlying metal powder (a) it is observed that additionally further metal is deposited analogously to step (B1).

Step (B2) may be carried out for example by applying a current having a strength in the range from 10 to 100 A and preferably in the range from 12 to 50 A.

Step (B2) may be carried out for example by using an external source of voltage for a period in the range from 1 to 160 hours.

In one embodiment of the present invention, step (B1) and step (B2) are combined by initially operating without and then with an external source of voltage and the further metal in step (B) having a more strongly positive standard potential in the electro-chemical series of the elements than the metal underlying metal powder (a).

One embodiment of the present invention comprises adding one or more auxiliaries to the solution of further metal. Examples of useful auxiliaries include buffers, surfactants, polymers, in particular particulate polymers whose particle diameter is in the range from 10 nm to 10 μm, defoamers, one or more organic solvents, one or more complexing agents.

Acetic acid/acetate buffers are particularly useful buffers.

Particularly suitable surfactants are selected from cationic, anionic and in particular nonionic surfactants.

As cationic surfactants there may be mentioned for example: C₆-C₁₈-alkyl-, -aralkyl- or heterocyclyl-containing primary, secondary, tertiary or quaternary ammonium salts, alkanolammonium salts, pyridinium salts, imidazolinium salts, oxazolinium salts, morpholinium salts, thiazolinium salts and also salts of amine oxides, quinolinium salts, isoquinolinium salts, tropylium salts, sulfonium salts and phosphonium salts. Examples which may be mentioned are dodecylammonium acetate or the corresponding hydrochloride, the chlorides or acetates of the various 2-(N,N,N-trimethylammonium)-ethylparaffinic esters, N-cetylpyridinium chloride, N-laurylpyridinium sulfate and also N-cetyl-N,N,N-trimethylammonium bromide, N-dodecyl-N,N,N-trimethylammonium bromide, N,N-distearyl-N,N-dimethylammonium chloride and also the gemini surfactant N,N′-(lauryldimethyl)ethylenediamine dibromide.

Examples of suitable anionic surfactants are alkali metal and ammonium salts of alkyl sulfates (alkyl radical: C₈ to C₁₂), of sulfuric acid monoesters of ethoxylated alkanols (degree of ethoxylation: 4 to 30, alkyl radical: C₁₂-C₁₈) and of ethoxylated alkylphenols (degree of ethoxylation: 3 to 50, alkyl radical: C₄-C₁₂), of alkylsulfonic acids (alkyl radical: C₁₂-C₁₈), of alkylarylsulfonic acids (alkyl radical: C₉-C₁₈) and of sulfosuccinates such as for example sulfosuccinic mono- or diesters. Preference is given to aryl- or alkyl-substituted polyglycol ethers and also to substances described in U.S. Pat. No. 4,218,218, and homologs with y (from the formulae of U.S. Pat. No. 4,218,218) in the range from 10 to 37. Particular preference is given to nonionic surfactants such as for example singly or preferably multiply alkoxylated C₁₀-C₃₀ alkanols, preferably with three to one hundred mol of C₂-C₄-alkylene oxide, in particular ethoxylated oxo process or fatty alcohols.

Suitable defoamers are for example siliconic defoamers such as for example those of the formula HO—(CH₂)₃—Si(CH₃)[OSi(CH₃)₃]₂ and HO—(CH₂)₃—Si(CH₃)[OSi(CH₃)₃][OSi(CH₃)₂OSi(CH₃)₃], nonalkoxylated or alkoxylated with up to 20 equivalents of alkylene oxide and especially ethylene oxide. Silicone-free defoamers are also suitable, examples being multiply alkoxylated alcohols, for example fatty alcohol alkoxylates, preferably 2 to 50-tuply ethoxylated preferably unbranched C₁₀-C₂₀ alkanols, unbranched C₁₀-C₂₀ alkanols and 2-ethylhexan-1-ol. Further suitable defoamers are fatty acid C₈-C₂₀-alkyl esters, preferably C₁₀-C₂₀-alkyl stearates, in each of which C₈-C₂₀-alkyl and preferably C₁₀-C₂₀-alkyl may be branched or unbranched.

Suitable complexing agents are such compounds as form chelates. Preference is given to such complexing agents as are selected from amines, diamines and triamines bearing at least one carboxylic acid group. Suitable examples are nitrilotriacetic acid, ethylenediaminetetraacetic acid and diethylenepentaminepentaacetic acid and also the corresponding alkali metal salts.

Step (C) comprises combining at least one textile metalized as described above with one or more plies of textile which may likewise each be metalized. The combining may be accomplished for example by placing on top of each other, for example by laying on top of each other.

After the placing on top of each other, three or more plies of textile, metalized or non-metalized, may be composited with each other to produce a composite article. The compositing may be accomplished uniformly or partially, for example at points (point-shapedly) or in the form of seams.

The compositing can be accomplished for example by stitching, needling, adhering, quilting, laminating or welding, in each case uniformly, partly or else point-shapedly. More preferably, one ply of textile may be uniformly laminated, point-shapedly adhered, partly stitched or quilted with or to another ply of textile.

One embodiment of the present invention comprises performing one or more thermal treating steps (D) following step (A) or following step (B). In the realm of the present invention, thermal treating steps performed immediately after step (A) shall also be known as thermal treating steps (D1) and thermal treating steps performed immediately after step (B) shall also be known as thermal treating steps (D2).

When it is desired to carry out a plurality of thermal treating steps, the various thermal treating steps can be carried out at the same temperature or preferably at different temperatures.

Step (D) or each individual step (D) may comprise treating for example at temperatures in the range from 50 to 200° C. Care must be taken to ensure that the thermal treatment of step (D) does not soften or even melt the material of the textile surface used as a starting material. Thus, the temperature is always kept below the softening or melting point of the textile material in question, or the duration of the thermal treatment is made too short for softening or even melting to take place.

Treatment duration in step (D) or each individual step (D) may range for example from 10 seconds to 15 minutes and preferably from 30 seconds to 10 minutes.

Particular preference is given to treating in a first step (D1) at temperatures in the range of for example 50 to 110° C. for a period of 30 seconds to 3 minutes and in a second step (D2), subsequently, at temperatures in the range from 130° C. to 200° C. for a period of 30 seconds to 15 minutes.

Step (D) or each individual step (D) may be carried out in equipment known per se, for example in atmospheric drying cabinets, tenters or vacuum drying cabinets.

One specific embodiment of the present invention comprises performing after step (B) at least one further step selected from
(E) applying a corrosion-inhibiting layer or
(F) applying a flexible layer,
   the corrosion-inhibiting layer being rigid, for example nonbendable, or flexible.

Examples of suitable corrosion-inhibiting layers are layers of one or more of the following materials: waxes, especially polyethylene waxes, paints, for example waterborne paints, 1,2,3-benzotriazole and salts, especially sulfates and methosulfates of quaternized fatty amines, for example lauryl/myristyl-trimethylammonium methosulfate.

Examples of flexible layers are foils, in particular polymeric foils, for example of polyester, polyvinyl chloride, thermoplastic polyurethane (TPU) or especially polyolefins such as for example polyethylene or polypropylene, the terms polyethylene and polypropylene each also comprehending copolymers of ethylene and propylene respectively.

Another embodiment of the present invention comprises applying as flexible layer a binder (b2), which may be the same as or different from any printed binder (b1) from step (A).

The applying may each be effected by laminating, adhering, welding, blade coating, printing, spraying or casting.

When a binder has been applied in step (F), a thermal treatment in accordance with step (D) may again be carried out subsequently.

The invention is elucidated by working examples.

### I. Production of a Printing Paste

The following were stirred together:

54 g of water
750 g of carbonyl iron powder, d₁₀ 3 μm, d₅₀ 4.5 μm, d₉₀ 9 μm, passivated with a microscopically thin iron oxide layer.
125 g of an aqueous dispersion, pH 6.6, solids content 39.3% by weight, of a random emulsion copolymer of 1 part by weight of N-methylolacrylamide, 1 part by weight of acrylic acid, 28.3 parts by weight of styrene, 69.7 parts by weight of n-butyl acrylate, parts by weight all based on total solids, average particle diameter (weight average) 172 nm, determined by Coulter Counter, T_{g}: −19° C. (binder b.1)
dynamic viscosity (23° C.) 70 mPa·s,
20 g of compound of the formula

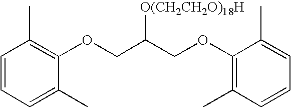

20 g of a 51% by weight solution of a reaction product of hexamethylene diisocyanate with n-C₁₈H₃₇(OCH₂CH₂)₁₅OH in isopropanol/water (volume fractions 2:3)

Stirring was done for 20 minutes at 5000 rpm (Ultra-Thurrax) to obtain a printing paste having a dynamic viscosity of 30 dPa·s at 23° C., measured using a Haake rotary viscometer.

### II. Printing of Textile, Step (A), and Thermal Treatment, Step (D1)

The print paste of I. was used to print a polyester nonwoven, basis weight 90 g/m², using an 80 mesh sieve uniformly on one side.

This was followed by drying in a drying cabinet at 100° C. for 10 minutes. A printed and thermally treated polyester nonwoven was obtained.

III. Deposition of a Further Metal, Step (B), without External Source of Voltage

Printed and thermally treated polyester nonwoven of II. was treated for 10 minutes in a bath (room temperature) having the following composition:

### 1.47 kg of CuSO₄.5H₂O

### 382 g of H₂SO₄

5.1 l of distilled water

### 1.1 g of NaCl

5 g of C₁₃/C₁₅-alkyl-O-(EO)₁₀(PO)₅—CH₃

### (EO: CH₂—CH₂—O, PO: CH₂—CH(CH₃)—O)

The polyester nonwoven was removed, rinsed twice under running water and dried at 90° C. for one hour.

Metalized polyester nonwoven PES-1 was obtained.

IV. Production of a Multi-Ply Material which is in Accordance with the Present Invention

Two pieces of a metalized textile of Example III which were cut to the same format were taken. The respectively metalized side was screen printed, in a point-shaped pattern, with a commercially available adhesive formulation consisting of an isocyanato-containing polymer. These textiles were then laid onto both sides of a third, non-metalized textile (90 g/m² basis weight polyester nonwoven), so that the adhesive-printed side in each case faced the third textile, and the assembly was compression molded at 80° C. for one minute to form a multi-ply material which was in accordance with the present invention and which was configured as a flexible composite consisting of two plies of metalized textile and one ply of non-metalized textile.

The multi-ply system of the present invention is extremely stable to scuffing and to stabs with a sharp kitchen knife. The mechanical stability does not decrease significantly even after a point-shaped site of damage has been inflicted.

1. A multi-ply material comprising at least a first and a second metalized layer on at least one textile, produced by
(A) applying onto at least a first and a second textile surface, in the form of a pattern or uniformly, a formulation comprising at least one metal powder (a) as a component,
(B) depositing a further metal on the textile surfaces,
(C) combining with at least a first ply of textile which may likewise be metalized.

2. The multi-ply material according to claim 1 wherein the formulation in the applying comprises:
(a) at least one metal powder,
(b) at least one binder,
(c) at least one emulsifier,
(d) optionally, at least one rheology modifier.

3. The multi-ply material according to claim 1, wherein the applying comprises printing with a printing formulation comprising at least one metal powder (a).

4. The multi-ply material according to claim 1, wherein emulsifier (c) is at least one selected from the group consisting of nonionic emulsifiers.

5. The multi-ply material according to claim 1, wherein metal powder (a) comprises a metal powder obtained by thermal decomposition of iron pentacarbonyl.

6. The multi-ply material according to claim 1, wherein the metal deposited in the depositing comprises copper.

7. The multi-ply material according to claim 1, comprising the at least first ply and at least a second ply of textile, each treated according to the applying and the depositing.

8. The multi-ply material according to claim 1, wherein the first and a last ply of textile is either not treated according to the applying and the depositing or is treated according to the applying and the depositing on the respective inside surface.

9. The multi-ply material according to claim 1 wherein the at least first ply, and at least a second and a third ply are composited together to form a composite article.

10. A method for manufacturing a protective apparel, comprising integrating at least one multi-ply material according to claim 1 into a protective apparel.

11. A method for manufacturing a mechanically stressed article, comprising integrating at least one multi-ply material according to claim 1 into the mechanically stressed article.

12. A protective apparel comprising at least one multi ply material according to claim 1.

13. A mechanically stressed article comprising at least one multi ply material according to claim 1.

14. A process for producing a multi ply material according to claim 1, comprising
(A) applying onto at least a first and a second textile surface, in the form of a pattern or uniformly, a formulation comprising at least one metal powder (a) as a component,
(B) depositing a further metal on the at least first and second textile surfaces,
(C) combining with at least a first ply of textile which may likewise be metalized.

15. The process according to claim 14, wherein the formulation in the applying comprises an aqueous formulation.

16. The process according to claim 14 wherein no external source of voltage is used in the depositing and the further metal in the depositing has a more strongly positive standard potential in the electrochemical series of the elements than the metal powder (a) metal.

17. The process according to claim 14 wherein an external source of voltage is used in the depositing and the further metal in the depositing has a more strongly or more weakly positive standard potential in the electrochemical series of the elements than the metal powder (a) metal.

18. The process according to claim 14, further comprising at least one thermal treating (D), carried out after the applying or the depositing.

19. The process according to claim 14, wherein the at least first ply and at least a second ply are bonded together by laminating, adhering, stitching or quilting.
